(19) United States
(12) Patent Application Publication
(10) Pub. No.: US 2017/0042384 A1
(43) Pub. Date: Feb. 16, 2017

(54) TOOTHBRUSH AND TOOTHPASTE HOLDING ASSEMBLY

(71) Applicant: Jerome Margolin, Monroe Township, NJ (US)

(72) Inventor: Jerome Margolin, Monroe Township, NJ (US)

(21) Appl. No.: 14/826,606

(22) Filed: Aug. 14, 2015

(51) Int. Cl. A47K 1/09; F16M 11/28

(52) U.S. Cl. CPC A47K 1/09; F16M 11/28

(57) ABSTRACT

A toothbrush and toothpaste holding assembly includes a base that has a top side and a bottom side. A post has a bottom end and a top end. The post is telescopic such that a height from the bottom end to the top end is adjustable. A central member is attached to and extends upwardly from the top end of the post. The central member has a first lateral side, a second lateral side, and a top side. A protrusion is attached to and extends forward from a front side of the central member. The protrusion has an upper surface having a well extending therein for receiving a toothpaste container. The protrusion has a plurality of vertically oriented apertures extending therethrough. Each of the apertures receives a toothbrush.

### BACKGROUND OF THE DISCLOSURE

### Field of the Disclosure

The disclosure relates to toothbrush holding devices and more particularly pertains to a new toothbrush holding device for supporting a plurality of toothbrushes and other articles such as soap, containers and the like to facilitate usage of such by a child.

### SUMMARY OF THE DISCLOSURE

An embodiment of the disclosure meets the needs presented above by generally comprising a base that has a top side and a bottom side. A post has a bottom end and a top end. The post is telescopic such that a height from the bottom end to the top end is adjustable. A central member is attached to and extends upwardly from the top end of the post. The central member has a first lateral side, a second lateral side, and a top side. A protrusion is attached to and extends forward from a front side of the central member. The protrusion has an upper surface having a well extending therein configured for receiving a toothpaste container. The protrusion has a plurality of vertically oriented apertures extending therethrough. Each of the apertures is configured for receiving a toothbrush.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a toothbrush and toothpaste holding assembly according to an embodiment of the disclosure.

FIG. 2 is a top view of an embodiment of the disclosure.

FIG. 3 is a rear view of an embodiment of the disclosure.

FIG. 4 is a side broken view of an embodiment of the disclosure.

### DESCRIPTION OF THE PREFERRED EMBODIMENT

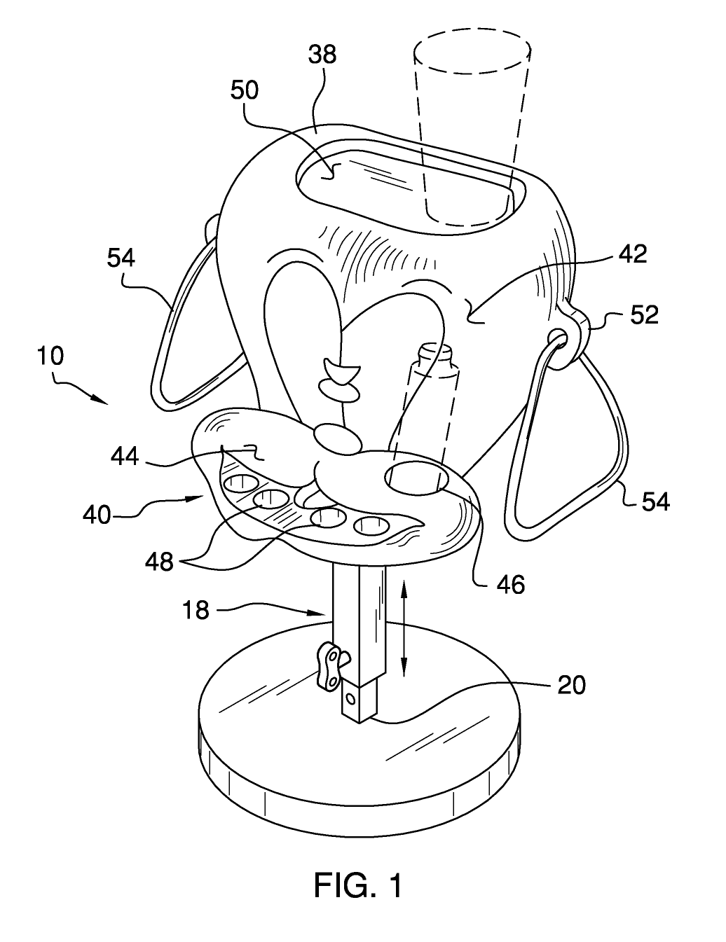

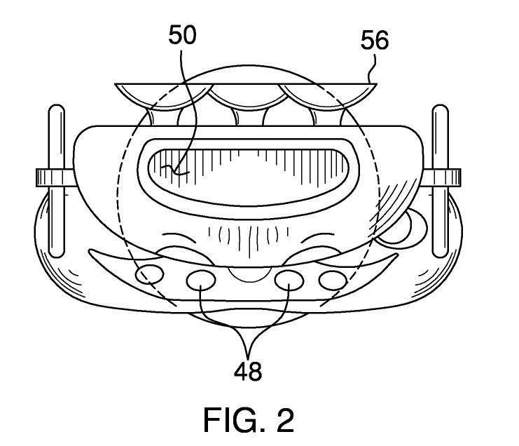

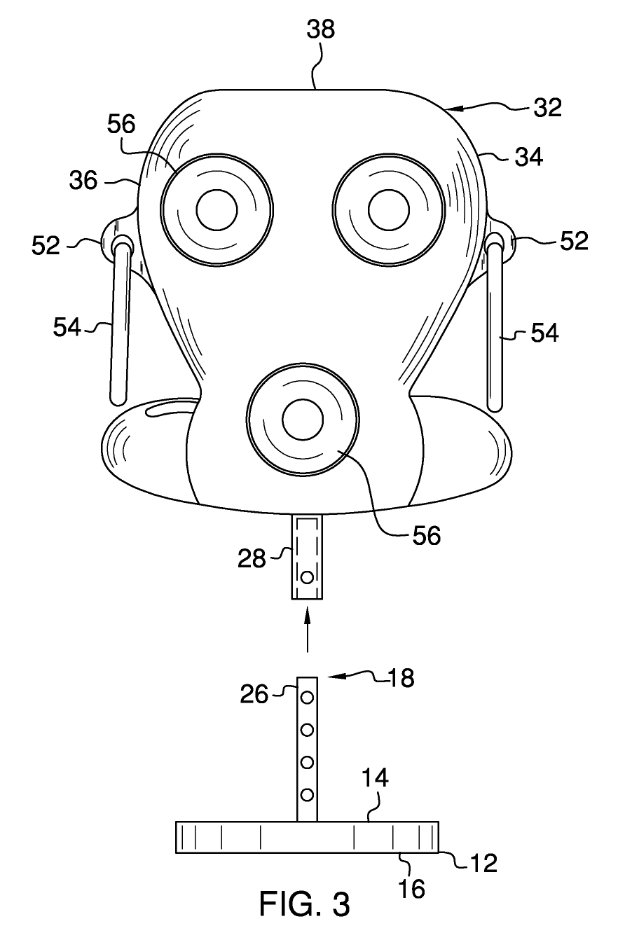

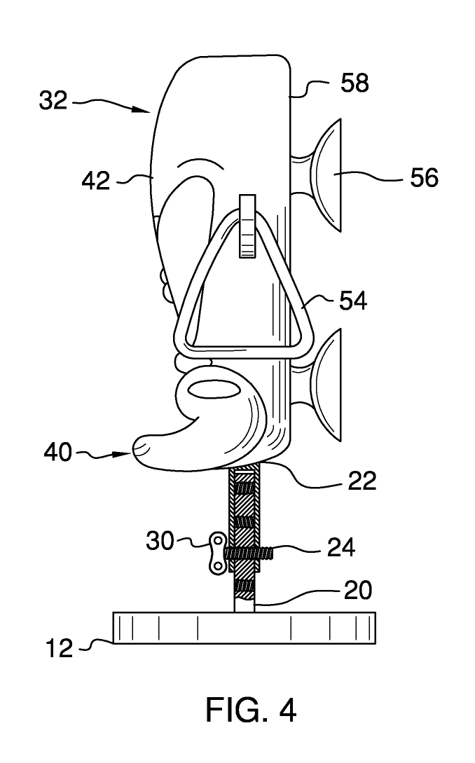

With reference now to the drawings, and in particular to FIGS. 1 through 4 thereof, a new toothbrush holding device embodying the principles and concepts of an embodiment of the disclosure and generally designated by the reference numeral 10 will be described.

As best illustrated in FIGS. 1 through 4, the toothbrush and toothpaste holding assembly 10 generally comprises a base 12 has a top side 14 and a bottom side 16. The base 12 has a length and width each being greater than 3.0 inches. A post 18 has a bottom end 20 and a top end 22. The post 18 is telescopic such that a height from the bottom end 20 to the top end 22 is adjustable. A locking member 24 releasably locks the post 18 at a selected height. The post 18 includes a lower section 26 and an upper section 28 slidably engaged to each other. The locking member 24 comprises a rod extending through each of the upper 28 and lower 26 sections. The locking member 24 may be threaded such that it threadably engages one of the upper 28 or lower 26 sections. A grip 30 is attached to one end of the locking member 24. The post 18 may have an adjustable height such that it may be altered from 3.0 inches to 10.0 inches.

A central member 32 is attached to and extends upwardly from the top end 22 of the post 18. The central member 32 has a first lateral side 34, a second lateral side 36 and a top side 38. A protrusion 40 is attached to and extends forward from a front side 42 of the central member 32. The protrusion 40 has an upper surface 44 having a well 46 extending therein and configured for receiving a toothpaste container. The protrusion 40 has a plurality of vertically oriented apertures 48 extending therethrough. Each of the apertures 48 is configured for receiving a toothbrush. The top side 38 has a depression 50 therein which has a length equal to at least 3.0 inches and a width equal to at least 2.0 inches. The depression 50 may be used for holding a drinking glass, a bar of soap and the like.

A pair of tabs 52 is provided and each of the first 34 and second 38 lateral walls has one of the tabs 52 attached thereto. A pair of loops 54 is also provided. Each of the tabs 52 has one of the loops 54 attached thereto. Each of the loops 54 is configured to receive a towel such as a hand towel. The central member 32 and the protrusion 40 may resemble a head of a stylized canine wherein the loops 54 may be shaped to resemble ears of the canine.

As an auxiliary support feature, a plurality of suction cups 56 may be attached to a rear side 58 of the central member 32. The suction cups 56 will allow the central member 32 to be removed from the base 12 and be attached to a flat surface such as a mirror.

In use, assembly 10 is utilized to hold a variety of items needed by a person, and in particular a child, while cleaning their teeth, hands and face. The post 18 has an adjustable height to allow the user to lower the central member 32 to be more accessible to a child and which may be increased in height as the child grows. The ability to alter its height and its appearance will encourage usage by a child.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A support assembly configured to hold a plurality of toothbrushes, said assembly comprising:
a base having a top side and a bottom side;
a post having a bottom end and a top end, said post being telescopic such that a height from said bottom end to said top end is adjustable; and
a central member being attached to and extending upwardly from said top end of said post, said central member having a first lateral side, a second lateral side, and a top side, a protrusion being attached to and extending forward from a front side of said central member, said protrusion having an upper surface having a well extending therein configured for receiving a toothpaste container, said protrusion having a plurality of vertically oriented apertures extending therethrough, each of said apertures being configured for receiving a toothbrush.

2. The support assembly according to claim 1, further including a locking member releasably locking said post at a selected height.

3. The support assembly according to claim 1, wherein said post includes a lower section and an upper section slidably engaged to each other, said locking member comprising a rod extending through each of said upper and lower sections.

4. The support assembly according to claim 1, wherein said top side has a depression therein, said depression having a length equal to at least 3.0 inches and a width equal to at least 2.0 inches.

5. The support assembly according to claim 1, further including:
a pair of tabs, each of said first and second lateral walls having one of said tabs attached thereto; and
a pair of loops, each of said tabs having one of said loops attached thereto, each of said loops being configured to receive a towel.

6. The support assembly according to claim 1, wherein said central member and said protrusion resemble a head of a stylized canine.

7. A support assembly configured to hold a plurality of toothbrushes, said assembly comprising:
a base having a top side and a bottom side;
a post having a bottom end and a top end, said post being telescopic such that a height from said bottom end to said top end is adjustable, a locking member releasably locking said post at a selected height, said post including a lower section and an upper section slidably engaged to each other, said locking member comprising a rod extending through each of said upper and lower sections;
a central member being attached to and extending upwardly from said top end of said post, said central member having a first lateral side, a second lateral side, and a top side, a protrusion being attached to and extending forward from a front side of said central member, said protrusion having an upper surface having a well extending therein configured for receiving a toothpaste container, said protrusion having a plurality of vertically oriented apertures extending therethrough, each of said apertures being configured for receiving a toothbrush, said top side having a depression therein, said depression having a length equal to at least 3.0 inches and a width equal to at least 2.0 inches;
a pair of tabs, each of said first and second lateral walls having one of said tabs attached thereto;
a pair of loops, each of said tabs having one of said loops attached thereto, each of said loops being configured to receive a towel; and
said central member and said protrusion resembling a head of a stylized canine.
